(19) United States
(12) Patent Application Publication
(10) Pub. No.: US 2023/0012026 A1
(43) Pub. Date: Jan. 12, 2023

(54) FEATURE LEARNING SYSTEM, FEATURE LEARNING METHOD, AND NON-TRANSITORY COMPUTER READABLE MEDIUM

(71) Applicant: NEC Corporation, Minato-ku, Tokyo (JP)

(72) Inventor: Ryo Kawai, Tokyo (JP)

(73) Assignee: NEC Corporation, Minato-ku, Tokyo (JP)

(21) Appl. No.: 17/785,554

(22) PCT Filed: Dec. 24, 2019
(86) PCT No.: PCT/JP2019/050642

§ 371 Date: Jun. 15, 2022

(51) Int. Cl. G06N 20/00; G06K 9/62; G06V 40/10; G06V 10/764; G06V 10/75

(52) U.S. Cl. CPC G06N 20/00; G06K 9/6215; G06K 9/6256; G06V 40/107; G06V 40/10; G06V 10/764; G06V 10/76

(57) ABSTRACT

A feature learning system (100) includes a similarity definition unit (101), a learning data generation unit (102), and a learning unit (103). The similarity definition unit (101) defines a degree of similarity between two classes related to two feature vectors, respectively. The learning data generation unit (102) acquires the degree of similarity, based on a combination of classes to which a plurality of feature vectors acquired as processing targets belong, respectively, and generates learning data including the plurality of feature vectors and the degree of similarity. The learning unit (103) performs machine learning using the learning data.

### TECHNICAL FIELD

The present invention relates to a system, a method, and a program that perform efficient learning of an action of a person in an image.

### BACKGROUND ART

In recent years, many technologies for estimating an action of a person captured in an image of a surveillance camera or the like by processing the image by a computer have been developed. However, actions of a person are very complex and diverse. Therefore, even when a human can objectively estimate that two actions are “the same action,” it may be difficult for a computer to estimate whether the actions are the same due to the difference between the persons taking the actions, the difference between the surrounding environments where the actions are taken, and the like. Taking an example of an action of “running,” it is readily imaginable that running speed, positions of hands and feet, and the like vary by person. Further, even when the same person is running, it is readily imaginable that running speed, positions of hands and feet, and the like vary by environment such as a ground condition (such as a stadium or a sandy beach) and a degree of crowdedness of the surroundings, and the like. Specifically, estimation of an action of a person by a computer often requires dealing with different persons and environments by preparing a very large number of pieces of learning data. However, a sufficient number of pieces of learning data may not be prepared depending on an action to be recognized.

Note that, for example, a method of using the final layer in principal component analysis or deep learning may be considered as a method of causing a computer to perform learning on an action of a person. As for the method of using the final layer in deep learning, use of metric learning as described in Non-Patent Document 1 and Non-Patent Document 2 may be considered. The metric learning focuses on a distance on a vector space of a feature value instead of the feature value itself and advances learning in such a way as to construct a feature space in which similar actions are placed close to each other, and different actions are placed distant from each other.

However, as for the term “different actions,” there may be a case of a difference in appearance being not so significant. For example, a combination of a normal walking action and an action of falling on the road, and a combination of an action of walking while using a smartphone or the like (hereinafter referred to as “walking with a smartphone in use”) and an action of walking simply with downcast eyes (hereinafter referred to as “downcast walking”) are considered. While each of the two cases represents a combination of “different actions”, appearances are significantly different in the former, whereas appearances are not significantly different in the latter. In other words, the former may be referred to as “totally different actions,” whereas the latter may be referred to as “similar but different actions.”

Conventional metric learning advances learning while handling both “totally different actions” and “similar but different actions” simply as “different actions.” However, attempting to forcibly separate “similar but different actions” on a feature space as “different actions” may adversely affect identification precision of a learning model due to, for example, performing learning on conversion exaggerating a slight difference (such as a difference based on a difference in body shape or a personal habit) existing in learning data and being irrelevant to the difference in action. A learning technique considering similarity has been proposed as a technique supporting such data with varying degrees of “difference.”

For example, in selection of a résumé of a job-hunter satisfying a condition on a job-offer application card of a company, Patent Document 1 allows highly precise extraction of a target résumé from a small number of learning documents by putting together keywords in the documents into several topics and performing learning, based on the topics.

### RELATED DOCUMENT

### Patent Document

Patent Document 1: Japanese Patent Application Publication No. 2017-134732

### Non Patent Document

Non-Patent Document 1: R. Hadsell, S. Chopra, and Y. LeCun, “Dimensionality reduction by learning and invariant mapping,” Proceedings of the IEEE Conf. on Computer Vision and Pattern Recognition, 2006

Non-Patent Document 2: J. Wang et al., “Learning fine-grained image similarity with deep ranking,” Proceedings of the IEEE Conf on Computer Vision and Pattern Recognition, 2014

### DISCLOSURE OF THE INVENTION

### Technical Problem

As described above, performing learning (such as metric learning) with “totally different actions” and “similar but different actions” handled similarly as “different actions” may adversely affect identification precision of a learning model. On the other hand, putting together similar actions into groups, performing identification by group, and then performing identification in a group as is the case with topics in Patent Document 1 may allow identification considering similarity between actions. However, in the technology in Patent Document 1, a discriminator classifying groups during learning and a discriminator classifying actions in a group need to be separately generated, and identification similarly needs to be performed twice during identification. Therefore, there is a problem that it takes more time for learning and identification than in the past.

Several embodiments of the present invention have been made in view of the aforementioned problem. An object of the present invention is to provide a technology for reducing the time required for learning and identification of an action of a person.

### Solution to Problem

A feature learning system according to the present invention includes:

a similarity definition unit that defines a degree of similarity between two classes related to two feature vectors, respectively;

a learning data generation unit that acquires the degree of similarity, based on a combination of classes to which a plurality of feature vectors acquired as processing targets belong, respectively, and generates learning data including the plurality of feature vectors and the degree of similarity; and

a learning unit that performs machine learning using the learning data.

A feature learning method according to the present invention includes, by a computer:

defining a degree of similarity between two classes related to two feature vectors, respectively;

acquiring the degree of similarity, based on a combination of classes to which a plurality of feature vectors acquired as processing targets belong, respectively;

generating learning data including the plurality of feature vectors and the degree of similarity; and

performing machine learning using the learning data.

A program according to the present invention causes a computer to execute the aforementioned feature learning method.

### Advantageous Effects of Invention

A first problem-solving means according to the present invention provides a technology for reducing the time required for learning and identification of an action of a person.

### BRIEF DESCRIPTION OF THE DRAWINGS

The aforementioned object, other objects, features and advantages will become more apparent by use of the following preferred example embodiments and accompanying drawings.

FIG. 1 is a diagram illustrating a configuration of a feature learning system according to a first example embodiment.

FIG. 2 is a diagram illustrating an example of information stored in a feature DB.

FIG. 3 is a diagram for illustrating an operation example of a similarity definition unit.

FIG. 4 is another diagram for illustrating the operation example of the similarity definition unit.

FIG. 5 is a diagram illustrating an example of information stored in a similarity DB.

FIG. 6 is a diagram illustrating an example of information stored in the similarity DB.

FIG. 7 is a diagram illustrating an example of information stored in a learning DB.

FIG. 8 is a diagram illustrating another example of information stored in the learning DB.

FIG. 9 is a block diagram illustrating a hardware configuration of the feature learning system.

FIG. 10 is a flowchart illustrating a flow of processing in the feature learning system according to the first example embodiment.

FIG. 11 is a diagram illustrating a configuration of a feature learning system according to a second example embodiment.

FIG. 12 is a diagram illustrating an example of a screen output by a display processing unit.

FIG. 13 is a diagram illustrating another example of a screen output by the display processing unit.

### DESCRIPTION OF EMBODIMENTS

Example embodiments of the present invention are described below by using drawings. Note that, in every drawing, similar components are given similar signs, and description thereof is not repeated as appropriate. Further, each block in each block diagram represents a function-based configuration rather than a hardware-based configuration unless otherwise described. Further, a direction of an arrow in a diagram is for ease of understanding of a flow of information and does not limit a direction (unidirectional/bidirectional) of communication unless otherwise described.
1. First Example Embodiment
1.1 Outline

An example embodiment of the present invention is described below. For example, a feature learning system according to a first example embodiment extracts action features from sensor information and then determines a degree of similarity from a combination of action features undergoing learning. For example, a combination of action features and a degree of similarity are stored in a learning database (hereinafter denoted by a “learning DB”) in a state of being associated with each other. The feature learning system performs learning, based on the degree of similarity, during learning. Thus, action features with different degrees of difference in action can undergo learning in consideration of a degree of similarity therebetween, and therefore an effect of enabling more stable advancement of learning is provided.
1.2 System Configuration

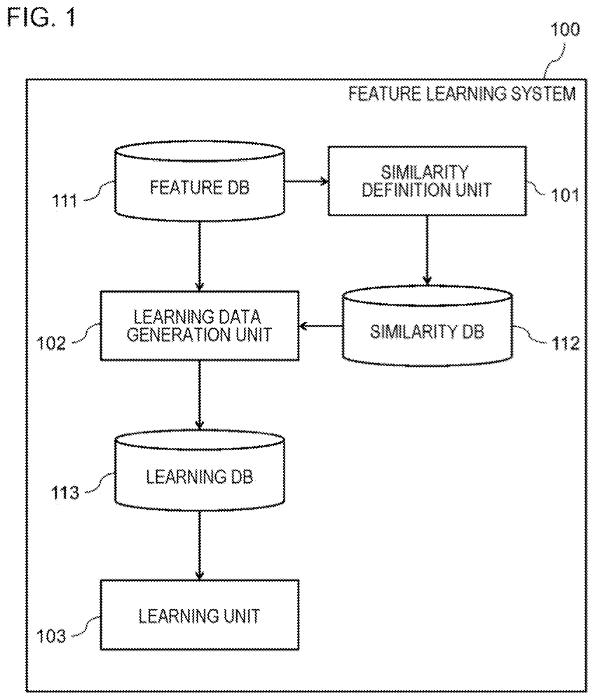

Referring to FIG. 1, an outline of the feature learning system according to the first example embodiment is described below. FIG. 1 is a diagram illustrating a configuration of the feature learning system 100 according to the first example embodiment.

The feature learning system 100 illustrated in FIG. 1 includes a feature database (hereinafter denoted by a “feature DB”) 111, a similarity definition unit 101, a similarity database (hereinafter denoted by a “similarity DB”) 112, a learning data generation unit 102, a learning DB 113, and a learning unit 103. Note that the components may be included in a single apparatus (computer) or may be included in a plurality of apparatuses (computers) in a distributed manner. It is assumed in the following description that a single apparatus (computer) includes all components in the feature learning system 100.

The feature DB 111 stores a plurality of action features along with class information related to each action feature. An action feature is information indicating a feature of an action of a person and is, for example, expressed by a vector in a certain feature space. For example, an action feature is generated based on information acquired by a sensor such as a visible light camera, an infrared camera, or a depth sensor (hereinafter also referred to as “sensor information”). Examples of an action feature include sensor information acquired by sensing an area where a person taking an action exists, skeletal information of the person generated based on the sensor information, and information acquired by converting the aforementioned information by using a predetermined function. However, an action feature may include another type of information. Note that an existing technique may be used for generation and acquisition of an action feature. Class information is information representing what action an action feature is related to, that is, the type of an action. For example, class information is manually input through an unillustrated input apparatus. In addition, class information may be given to each action feature acquired as described above, by using a learning model undergoing learning in such as way as to classify action features into relevant classes.

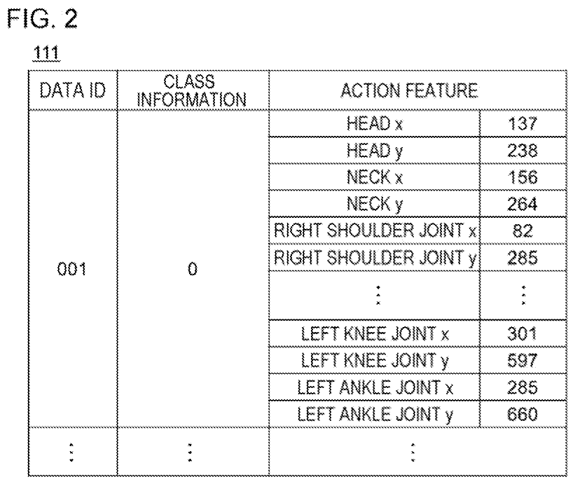

FIG. 2 is a diagram illustrating an example of information stored in the feature DB 111. In the example in FIG. 2, the feature DB 111 stores class information indicating the type of an action (such as a class 0) and an action feature related to the class (position coordinates of each keypoint of a person taking the action) in association with each other.

The similarity definition unit 101 defines a degree of similarity between two classes related to two action features, respectively, and stores the degree of similarity into the similarity DB 112. Note that, for example, a degree of similarity between action features is represented by a numerical value equal to or greater than 0 and equal to or less than 1. Further, in this case, a greater value (the numerical value becoming closer to 1) indicates a greater level of similarity between two action features constituting a group. Several methods may be considered as a method of defining a degree of similarity in the similarity definition unit 101. By rough classification, a method of defining a degree of similarity for each group of classes of actions and a method of individually defining a degree of similarity for each action feature may be cited. When a degree of similarity is individually defined for each action feature, the similarity definition unit 101 defines a mathematical equation for determining a degree of similarity.

Two examples of the method of defining a degree of similarity for each group of classes of actions are cited. It is assumed in the following two examples that the number of classes of action features stored in the feature DB 111 is n.

As a first example, a method of using principal component analysis may be considered. A specific example of the method is described with reference to an equation. In this case, for example, the similarity definition unit 101 may define a degree of similarity for each combination of classes as follows. Note that an operation described below is strictly an example, and the operation of the similarity definition unit 101 is not limited to the following example. First, the similarity definition unit 101 retrieves an action feature stored in the feature DB 111. Then, the similarity definition unit 101 classifies the action features retrieved from the feature DB 111 into related classes by using, for example, a learning model constructed by machine learning. Then, the similarity definition unit 101 performs principal component analysis on action features in each class and determines an eigenvector for an acquired first principal component. An eigenvector related to the first principal component in a class k (where 1≤k≤n) is denoted by vₖ. Then, a degree of similarity sᵢⱼ between a class i and a class j is defined as follows by using respective eigenvectors vᵢ and vⱼ of the class i and the class j.

$$\begin{matrix}[ Math . 1 ] & \\ {s}_{ij} = \frac{{v}_{i} \cdot {v}_{j}}{2 ‖ {v}_{i} ‖ ‖ {v}_{j} ‖} + 0.5 & ( 1 )\end{matrix}$$

The above corresponds to a value acquired by normalizing a cosine of an angle formed by vᵢ and vⱼ in such a way as to satisfy a condition of a degree of similarity. The similarity definition unit 101 stores every sᵢⱼ acquired when i and j are varied in a range [1, n] into the similarity DB 112.

As a second example, a method of temporarily performing learning and evaluation on an action feature by a conventional method and then setting a false recognition rate as a degree of similarity may be considered. In this case, for example, the similarity definition unit 101 may define a degree of similarity for each combination of classes as follows. Note that an operation described below is strictly an example, and the operation of the similarity definition unit 101 is not limited to the following example. First, the similarity definition unit 101 retrieves the same number of action features for each class from the feature DB 111. Then, the similarity definition unit 101 further classifies the retrieved action features in the class. For example, the similarity definition unit 101 sets part of the action features retrieved for each class (the same number for each class) as features for evaluation and the remainder as features for learning. Then, the similarity definition unit 101 performs learning by using the features for learning by the conventional method and then performs identification of the features for evaluation with an acquired discriminator (learning model). Then, the similarity definition unit 101 totalizes the identification result of the features for evaluation for each class. Then, based on the totalization result, the similarity definition unit 101 computes a ratio mₛₜ of cases of recognizing an action feature belonging to a class s as an action feature belonging to a class t. At this time, a degree of similarity sᵢⱼ between a class i and a class j is defined as follows by using a ratio mᵢⱼ of cases of recognizing an action feature belonging to the class i as an action feature belonging to the class j and a ratio mⱼᵢ of cases of recognizing an action feature belonging to the class j as an action feature belonging to the class i.

$$\begin{matrix}[ Math . 2 ] & \\ {s}_{ij} = \frac{{m}_{ij} + {m}_{j i}}{2} & ( 2 )\end{matrix}$$

For example, it is assumed that there are a class A and a class B, a ratio of mistaking an action feature belonging to the class A for an action feature belonging to class B is 0.2, and a ratio of mistaking an action feature belonging to the class B for an action feature belonging to the class A is 0.1. In this case, the similarity definition unit 101 can define the degree of similarity sᵢⱼ between the class i and the class j to be “0.15” by using aforementioned equation (2). The similarity definition unit 101 stores every sᵢⱼ when i and j are varied in a range [1, n] into the similarity DB 112.

As another example, a degree of similarity may be artificially defined. Examples of the case include defining a degree of similarity between a normal walking action and an action of falling down to be 0 and defining a degree of similarity between walking with a smartphone in use and downcast walking to be 0.25. In this case, for example, the similarity definition unit 101 may define a degree of similarity for each combination of classes as follows. Note that an operation described below is strictly an example, and the operation of the similarity definition unit 101 is not limited to the following example. First, the similarity definition unit 101 causes a screen for setting a degree of similarity for each combination of classes to be displayed on a display (unillustrated) used by an operator. The operator inputs a numerical value to be set for each combination of class on the screen displayed on the display. The similarity definition unit 101 may classify the whole or part of action features stored in the feature DB 111 into, for example, respective classes and display the classification result on the display. The operator may utilize the classification result of the action features for each class displayed on the display as support information when determining a degree of similarity of a combination of two different classes. For example, by referring to and comparing an action feature classified as a first class and an action feature classified as a second class, the operator can determine a numerical value to be set as a degree of similarity of a combination of the first and the second classes. When the similarity definition unit 101 does not have a function of displaying the aforementioned classification result on the display, for example, the operator may input a numerical value to be set, based on a sense of the operator. Then, the similarity definition unit 101 stores the numerical value input on the screen into the similarity DB 112 along with information indicating the combination of the classes.

On the other hand, examples of the method of defining a degree of similarity for each combination of action features include the following.

As a first example, a method of using principal component analysis may be considered. In this case, for example, the similarity definition unit 101 may define a degree of similarity for each combination of action features as follows. Note that an operation described below is strictly an example, and the operation of the similarity definition unit 101 is not limited to the following example. First, the similarity definition unit 101 retrieves every action feature from the feature DB 111 and performs principal component analysis. The similarity definition unit 101 may perform dimensionality reduction of an action feature, based on the result of the principal component analysis for each action feature. A conventional method may be used for the dimensionality reduction. Then, the similarity definition unit 101 sets a degree of similarity between feature vectors acquired from respective action features as a degree of similarity between the actions. Specifically, a degree of similarity s_{vw} between a first action feature V and a second action feature W can be defined as equation (3) below by using the norm (use of the L2 norm may be considered but another norm may also be used) of the difference between a feature vector v of the first action feature V and a feature vector w of the second action feature W.

$$\begin{matrix}[ Math . 3 ] & \\ {s}_{vw} = 1 - tanh \frac{‖ ν - w ‖}{2} & ( 3 )\end{matrix}$$

Further, the degree of similarity s_{vw} between the first action feature V and the second action feature W can be defined as equation (4) below by using the cosine of an angle formed by the feature vector v of the first action feature V and the feature vector w of the second action feature W.

$$\begin{matrix}[ Math . 4 ] & \\ {s}_{vw} = \frac{v \cdot w}{2 ‖ v ‖ ‖ w ‖} + 0.5 & ( 4 )\end{matrix}$$

In this case, a conversion equation for dimensionality reduction and the aforementioned definition equation of a degree of similarity are stored in the similarity DB 112.

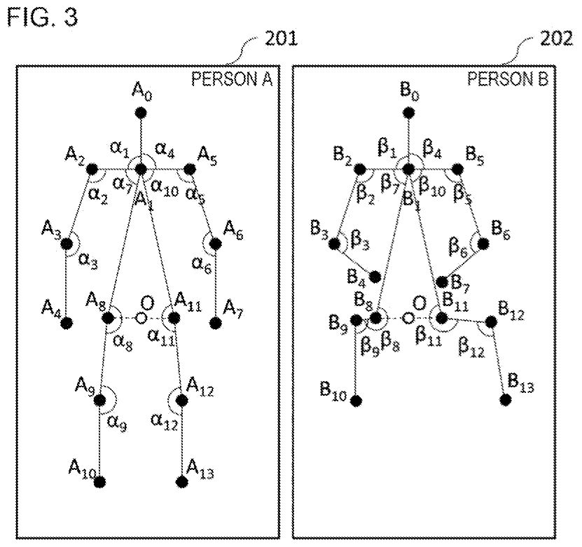

Further, setting similarity between action features themselves as a degree of similarity may also be considered. In this case, the similarity definition unit 101 defines an equation for determining a degree of similarity between two classes, based on two action features, without referring to the feature DB 111 and stores the equation into the similarity DB 112. A specific example of the method is described below referring to FIG. 3. FIG. 3 is a diagram for illustrating an operation example of the similarity definition unit 101. FIG. 3 illustrates skeletal information of each of persons A and B, the information being normalized based on height, as an example of an action feature. An example of comparing action features of the two persons is described.

The definition of each sign described in FIG. 3 is as follows. As illustrated in FIG. 3, points A₀ to A₁₃ and points B₀ to B₁₃ are keypoints of the person A and the person B, respectively. Note that indices (0 to 13) are related to parts being keypoints of a person. In the example in the diagram, the index “0,” the index “1,” the index “2,” the index “3,” the index “4,” the index “5,” the index “6,” the index “7,” the index “8,” the index “9,” the index “10,” the index “11,” the index “12,” and the index “13” represent the head, the neck, the right shoulder joint, the right elbow joint, the right wrist joint, the left shoulder joint, the left elbow joint, the left wrist joint, the right hip joint, the right knee joint, the right ankle joint, the left hip joint, the left knee joint, and the left ankle joint, respectively. Information about the keypoints may be considered as information indicating a skeleton of a person (human skeletal information). At this time, each point may be defined by the camera coordinate system or may be defined by the world coordinate system. In the example in the diagram, the middle point between both hip joints, that is, the middle point of each of a segment A₈A₁₁ and a segment B₈B₁₁ is set to the origin O. Then, vectors from the origin O toward the points A₀ to A₁₃ are denoted by a₀ to a₁₃, and vectors toward the points B₀ to B₁₃ are similarly denoted by b₀ to b₁₃. Further, α₁ to α₁₂ and β₁ to β₁₂ are defined as angles formed between segments connecting keypoints, as illustrated in FIG. 3.

A method of computing a degree of similarity s between action features or a distance d between action features is described below. The similarity definition unit 101 can convert the distance d between action features into the degree of similarity s in accordance with, for example, equation (5) below.

$$\begin{matrix}[ Math . 5 ] & \\ s = 1 - tanh \frac{d}{2} & ( 5 )\end{matrix}$$

Note that when a maximum value D of the distance d can be estimated due to a physical constraint or the like, the similarity definition unit 101 may compute the degree of similarity s in accordance with equation (6) below.

$$\begin{matrix}[ Math . 6 ] & \\ s = max ( 1 - \frac{d}{D} , 0 ) & ( 6 )\end{matrix}$$

Several specific examples of the method of computing the degree of similarity s or the distance d are described. As a first example, defining the distance d as equation (7) below may be considered. The similarity definition unit 101 may compute the total value of distances between related keypoints as the distance d between action features by using equation (7) below.

$$\begin{matrix}[ Math . 7 ] & \\ d = {\sum }_{k = 0}^{13} ‖ {a}_{k} - {b}_{k} ‖ & ( 7 )\end{matrix}$$

As a second example, the distance d may be defined as equation (8) below. The similarity definition unit 101 may compute the distance between the barycenter of keypoints of a first action feature and the barycenter of keypoints of a second action feature as the distance d between the action features by using equation (8) below.

$$\begin{matrix}[ Math . 8 ] & \\ d = \frac{1}{14} ‖ {{\sum }_{k = 0}}^{13} ( {a}_{k} - {b}_{k} ) ‖ & ( 8 )\end{matrix}$$

As third and fourth examples, the distance d may be defined as equation (9) or equation (10) below. Equation (9) and equation (10) below are acquired by excluding information other than information in a height direction from aforementioned equation (7) and equation (8), respectively, based on the fact that a difference in action due to a pose tends to be more apparent in the height direction than in a lateral direction. In the following equation, a_{y0} to a_{y13} and b_{y0} to b_{y13} denote elements of the vectors a₀ to a₁₃ and the vectors b₀ to b₁₃ in the height direction, respectively.

$$\begin{matrix}[ Math . 9 ] & \\ d = {\sum }_{k = 0}^{13} \vert {a}_{y k} - {b}_{y k} \vert & ( 9 )\end{matrix}$$

$$\begin{matrix}[ Math . 10 ] & \\ d = \frac{1}{14} \vert {\sum }_{k = 0}^{13} ( {a}_{y k} - {b}_{y k} ) \vert & ( 10 )\end{matrix}$$

As a fifth example, the degree of similarity s may be defined as equation (11) below by a procedure of determining an angle formed by vectors from an inner product.

$$\begin{matrix}[ Math . 11 ] & \\ s = \frac{1}{28} {{\sum }_{k = 0}}^{13} \frac{{a}_{k} \cdot {b}_{k}}{‖ {a}_{k} ‖ ‖ {b}_{k} ‖} + 0.5 & ( 11 )\end{matrix}$$

As a sixth example, the degree of similarity s may be defined as equation (12) below, based on an angle formed by segments connecting keypoints.

$$\begin{matrix}[ Math . 12 ] & \\ s = \frac{1}{24} {\sum }_{k = 1}^{12} cos ( {α}_{k} - {β}_{k} ) + 0.5 & ( 12 )\end{matrix}$$

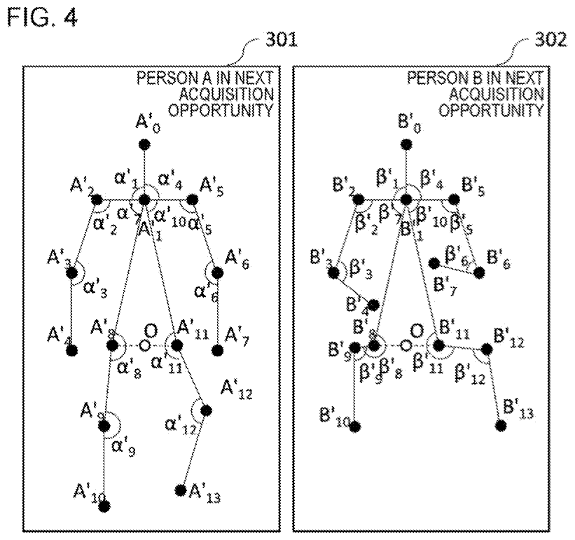

As seventh, eighth, ninth, and tenth examples, the similarity definition unit 101 may define the distance d between two action features or the degree of similarity s between two action features, based on movement information of keypoints of each person. In this case, the similarity definition unit 101 may chronologically acquire action features of each of the person A and the person B and compute movement information of keypoints of each person, based on a plurality of action features (temporally consecutive action features) acquired for each person. For example, it is assumed that, in an acquisition opportunity subsequent to FIG. 3, the position of each keypoint of the person A and the person B changes from a state illustrated in FIG. 3 to a state illustrated in FIG. 4. FIG. 4 is another diagram for illustrating the operation example of the similarity definition unit. In this case, for example, the distance d between two action features or the degree of similarity s between two action features may be defined as equation (13), equation (14), equation (15), or equation (16) below. The equations are acquired by modifying equation (7), equation (9), equation (11), and equation (12) to equations using movement information of keypoints of each person, respectively.

$$\begin{matrix}[ Math . 13 ] & \\ d = {{\sum }^{13}}_{k = 0} ‖ ( {a}_{k} - {a}_{k}^{′} ) - ( {b}_{k} - {b}_{k}^{′} ) ‖ & ( 13 )\end{matrix}$$

$$\begin{matrix}[ Math . 14 ] & \\ d = {{\sum }^{13}}_{k = 0} \vert ( {a}_{yk} - {a}_{yk}^{′} ) - ( {b}_{yk} - {b}_{yk}^{′} ) \vert & ( 14 )\end{matrix}$$

$$\begin{matrix}[ Math . 15 ] & \\ s = \frac{1}{28} {\sum }_{k = 0}^{13} \frac{( {a}_{k} - {a}_{k}^{′} ) \cdot ( {b}_{k} - {b}_{k}^{′} )}{‖ ( {a}_{k} - {a}_{k}^{′} ) ‖ ‖ ( {b}_{k} - {b}_{k}^{′} ) ‖} + 0.5 & ( 15 )\end{matrix}$$

$$\begin{matrix}[ Math . 16 ] & \\ s = \frac{1}{24} {\sum }_{k = 1}^{12} cos ( ( {α}_{k} - {α}_{k}^{′} ) — ( {β}_{k} - {β}_{k}^{′} ) ) + 0.5 & ( 16 )\end{matrix}$$

Note that part of keypoints of a target object may not be detected in an actually captured image. For example, when a target person faces a camera sideways, a keypoint of one arm of the person may not appear in the image. Therefore, as an eleventh example, the degree of similarity s between two action features may be defined based on whether a keypoint is detected. For example, defining the degree of similarity s as equation (17) below by using a function h(k) taking a value 1 when both Aₖ and Bₖ are detected or undetected and takes a value 0 when only either one is detected may be considered.

$$\begin{matrix}[ Math . 17 ] & \\ s = \frac{1}{14} {\sum }_{k = 0}^{13} h ( k ) & ( 17 )\end{matrix}$$

In addition, the similarity definition unit 101 may determine a degree of similarity to be stored in the similarity DB 112 by computing a plurality of degrees of similarity by using at least two or more of aforementioned equation (7) to equation (17) and integrating the degrees of similarity by averaging or the like.

While examples of computation of a degree of similarity have been cited above, a degree of similarity may be computed by a method other than the methods exemplified here. For example, a method of defining a degree of similarity for each class of action may be combined with a method of individually defining a degree of similarity for each action feature, an example of which being defining a degree of similarity to be 1 when actions belong to the same class and defining a degree of similarity for each feature when the actions belong to different classes.

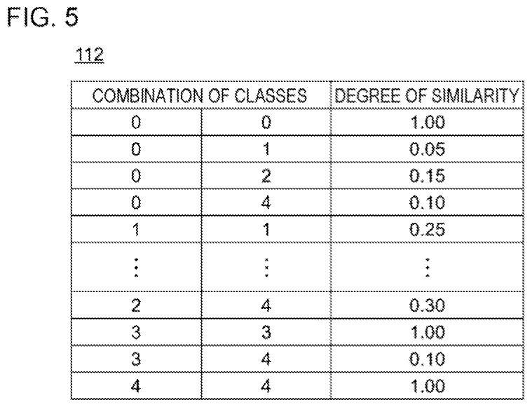

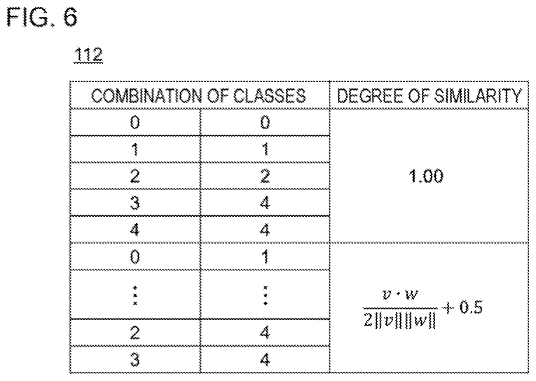

An example of information stored in the similarity DB 112 is described by using FIG. 5 and FIG. 6. FIG. 5 and FIG. 6 are diagrams illustrating examples of information stored in the similarity DB 112. FIG. 5 and FIG. 6 illustrate examples of information when five classes being 0 to 4 exist. In the example in FIG. 5, the similarity DB 112 stores one degree of similarity for each combination of classes. Further, in the example in FIG. 6, the similarity DB 112 stores one degree of similarity for a combination of the same class and stores a mathematical equation for determining a degree of similarity for a combination of different classes. Note that the diagrams are strictly examples, and information stored in the similarity DB 112 is not limited to the diagrams.

The learning data generation unit 102 retrieves a plurality of action features from the feature DB 111 along with class information associated with each action feature. The learning data generation unit 102 may randomly retrieve a plurality of action features being processing targets from the feature DB 111 or may retrieve the action features from the feature DB 111 in accordance with a predetermined rule. Then, the learning data generation unit 102 optionally selects two action features out of the action features retrieved from the feature DB 111 and determines a combination of classes, based on class information associated with each of the two action features. Then, the learning data generation unit 102 retrieves a degree of similarity related to the determined combination of classes or a mathematical equation for determining a degree of similarity from the similarity DB 112. When a mathematical equation for determining a degree of similarity is retrieved from the similarity DB 112, the learning data generation unit 102 determines a degree of similarity by substituting the two selected action features into the mathematical equation. Finally, the learning data generation unit 102 stores the two selected action features and the degree of similarity acquired by using the information in the similarity DB 112 into the learning DB 113 as one set of learning data.

The learning unit 103 retrieves a required number of sets of a degree of similarity and action features from the learning DB 113 and performs machine learning. An existing technique may be used as a machine learning technique. Note that the learning unit 103 according to the present invention introduces a degree of similarity as a new variable and performs machine learning.

The configurations of the learning data generation unit 102 and the learning unit 103 are more specifically described below by citing several specific machine learning techniques. Note that, in the following examples, the learning data generation unit 102 generates learning data used for metric learning, and the learning unit 103 performs metric learning by using the learning data.

First, operation of the learning data generation unit 102 and the learning unit 103 when a Siamese network described in Non-Patent Document 1 is used is described.

A Siamese network sets two pieces of learning data as one group and advances learning in such a way as to decrease Loss indicated in equation (18) below.

$$\begin{matrix}[ Math . 18 ] & \\ Loss = \frac{s {d}^{2} + ( 1 - s ) {max ( m - d , 0 )}^{2}}{2} & ( 18 )\end{matrix}$$

It is assumed in aforementioned equation (18) that s takes a value 1 when a group of learning data includes the same class and takes a value 0 when the group includes different classes. Further, m denotes a constant called margin, and d represents the distance between the two pieces of learning data.

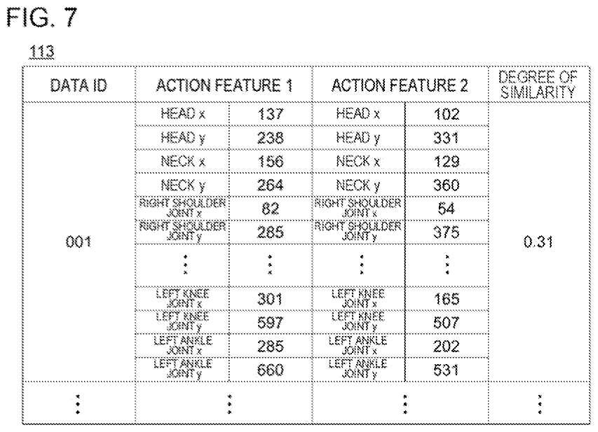

When the Siamese network is used, the learning data generation unit 102 first retrieves two action features from the feature DB 111. Then, the learning data generation unit 102 determines a degree of similarity between the two retrieved action features in the aforementioned manner, puts together the two action features and the degree of similarity acquired for the two action features into one set, and stores the set into the learning DB 113 (for example, FIG. 7). FIG. 7 is a diagram illustrating an example of information stored in the learning DB 113.

When the Siamese network is used, the learning unit 103 retrieves a required number of sets of two action features and a degree of similarity (learning data) from the learning DB 113 and performs machine learning. At this time, the learning unit 103 performs the learning with

Loss being aforementioned equation (18) in which the degree of similarity in the retrieved learning data is substituted for s.

Next, operation of the learning data generation unit 102 and the learning unit 103 when a triplet network described in Non-Patent Document 2 is used is described.

A triplet network sets three types of learning data being an anchor sample as a reference, a positive sample, and a negative sample as one group and advances learning in such a way as to decrease Loss indicated below. The positive sample belongs to the same class as the anchor sample. Further, the negative sample belongs to a class different from that of the anchor sample and the positive sample.

[Math. 19]

Loss=max(dₚ−dₙ+m,0) (19)

In aforementioned equation (19), dₚ represents the distance between the anchor sample and the positive sample. Further, dₙ represents the distance between the anchor sample and the negative sample. Further, m denotes a constant called margin.

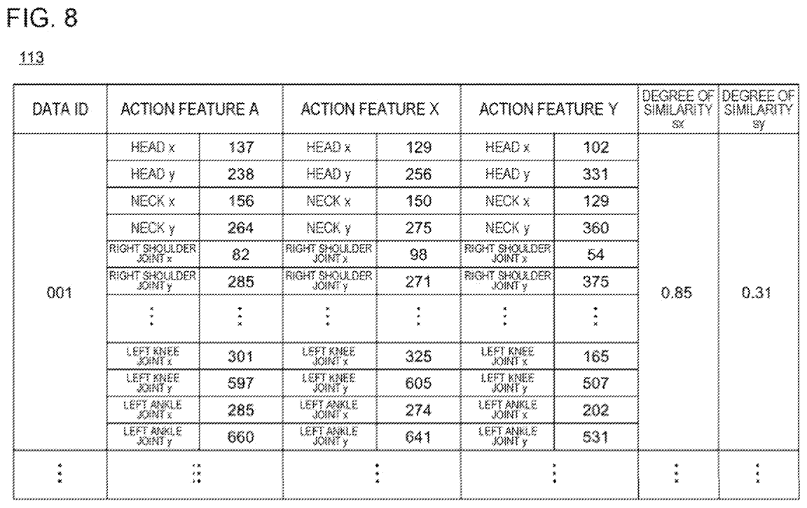

When the triplet network is used, the learning data generation unit 102 retrieves an action feature (denoted by A) to be an anchor sample and two action features (denoted by X and Y) from the feature DB 111. Then, the learning data generation unit 102 determines a degree of similarity between the action features A and X and a degree of similarity between the action features A and Y in the aforementioned manner. It is desirable to select the action feature X and the action feature Y in such a way that the difference between the two determined degrees of similarity increases. For example, the learning data generation unit 102 may increase the difference between the two degrees of similarity by selecting one of the action feature X and the action feature Y from the same class as the action feature A and selecting the other from a class different from that of the action feature A. In addition, the learning data generation unit 102 may compute a degree of similarity with the action feature A for each of the action feature X and the action feature Y randomly extracted from the feature DB 111 and select two action features to be used with the action feature A in the processing, based on the difference between the computed degree of similarity between A and X and the computed degree of similarity between A and Y. For example, the learning data generation unit 102 may be configured to select the action feature X and the action feature Y as action features to be used in generation of learning data when the difference between the computed degree of similarity between A and X and the computed degree of similarity between A and Y is equal to or greater than a predetermined threshold value (such as 0.5) and not to select the action feature X and the action feature Y when the difference is less than the predetermined threshold value. As yet another example, the learning data generation unit 102 may be configured to, for example, provide a user with a screen including a computation result of the degree of similarity between A and X and the degree of similarity between A and Y and determine whether to select the action features X and Y as two action features to be used with the action feature A in the processing, based on a user selection operation on the screen. Then, the learning data generation unit 102 puts together the three action features (A, X, and Y) and the two degrees of similarity (the degree of similarity between A and X and the degree of similarity between A and Y) into one set and stores the set into the learning DB 113 (for example, FIG. 8). FIG. 8 is a diagram illustrating another example of information stored in the learning DB 113.

When the triplet network is used, the learning unit 103 retrieves a required number of sets of three action features and two degrees of similarity (learning data) from the learning DB 113 and performs machine learning. At this time, the learning unit 103 defines Loss as follows.

[Math. 20]

Loss=max((2sₓ−1)dₓ+(2s_{y}−1)d_{y}+m,0) (20)

Note that sₓ and s_{y} represent a degree of similarity between the action features A and X and a degree of similarity between the action features A and Y, respectively. Further, dₓ and d_{y} represent the distance between the action features A and X and the distance between the action features A and Y, respectively. It should be noted that assuming X to be a positive sample, Y to be a negative sample, sₓ to be 1, and s_{y} to be 0 in aforementioned equation (20), Loss matches that in a conventional triplet network.

While detailed configurations of the learning data generation unit 102 and the learning unit 103 have been described above for each machine learning technique, the units may be independently configured by using a technique of machine learning other than the above.
1.3 Hardware Configuration Example

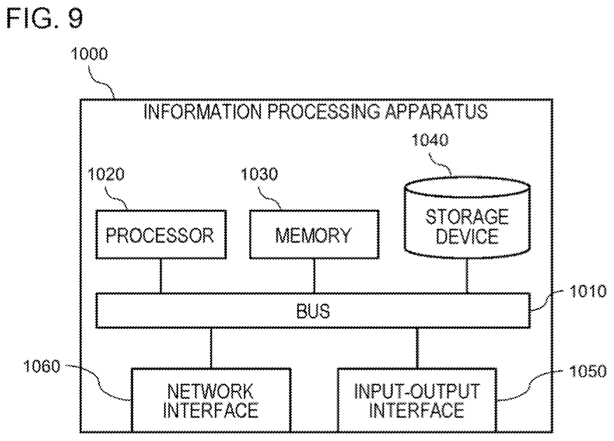

FIG. 9 is a block diagram illustrating a hardware configuration of the feature learning system 100. In the example in the diagram, the components in the feature learning system (the similarity definition unit 101, the learning data generation unit 102, and the learning unit 103) are provided by an information processing apparatus 1000 (computer). The information processing apparatus 1000 includes a bus 1010, a processor 1020, a memory 1030, a storage device 1040, an input-output interface 1050, and a network interface 1060.

The bus 1010 is a data transmission channel for the processor 1020, the memory 1030, the storage device 1040, the input-output interface 1050, and the network interface 1060 to transmit and receive data to and from one other. Note that the method of interconnecting the processor 1020 and other components is not limited to a bus connection.

The processor 1020 is a processor provided by a central processing unit (CPU), a graphics processing unit (GPU), or the like.

The memory 1030 is a main storage provided by a random access memory (RAM) or the like.

The storage device 1040 is an auxiliary storage provided by a hard disk drive (HDD), a solid state drive (SSD), a memory card, a read only memory (ROM), or the like. The storage device 1040 stores program modules providing the functions of the information processing apparatus 1000 (the similarity definition unit 101, the learning data generation unit 102, the learning unit 103, and the like). By reading each program module into the memory 1030 and executing the program module by the processor 1020, each function related to the program module is provided.

The input-output interface 1050 is an interface for connecting the information processing apparatus 1000 to various input-output devices. For example, the input-output interface 1050 may be connected to input apparatuses such as a mouse, a keyboard, and a touch panel, and output apparatuses such as a display.

The network interface 1060 is an interface for connecting the information processing apparatus 1000 to a network. For example, the network is a local area network (LAN) or a wide area network (WAN). The method of connecting the network interface 1060 to the network may be a wireless connection or a wired connection.

Note that the hardware configuration of the information processing apparatus 1000 is not limited to the configuration illustrated in FIG. 3.
1.4 Flow of Processing

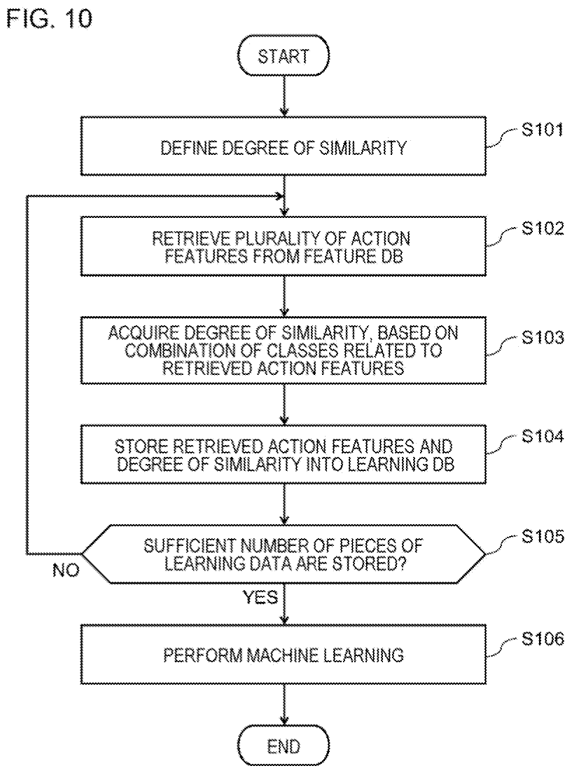

A flow of processing in the feature learning system according to the first example embodiment is described below referring to FIG. 10. FIG. 10 is a flowchart illustrating a flow of processing in the feature learning system 100 according to the first example embodiment.

First, the similarity definition unit 101 defines a degree of similarity for a combination of classes of action features and stores the defined degree of similarity into the similarity DB 112 (Step S101: hereinafter simply denoted by S101).

The learning data generation unit 102 optionally selects and retrieves a plurality of action features from the feature DB 111 (S102). Then, based on a combination of classes related to the two retrieved action features, the learning data generation unit 102 refers to the similarity DB 112 and acquires a degree of similarity related to the combination (S103). For example, when the Siamese network is used, the learning data generation unit 102 retrieves two action features from the feature DB 111. Then, the learning data generation unit 102 acquires a degree of similarity related to a combination of a first class to which one of the two retrieved action features belongs and a second class to which the other belongs, based on information stored in the similarity DB 112. For example, it is assumed that a class of one of the two retrieved action features is “0” and a class of the other is “1.” When the information as illustrated in FIG. 5 is stored in the similarity DB 112, the learning data generation unit 102 can acquire information “0.05” from the similarity DB 112 as a degree of similarity related to a combination of the classes. Further, when the information as illustrated in FIG. 6 is stored in the similarity DB 112, the learning data generation unit 102 retrieves a mathematical equation for determining a degree of similarity from the similarity DB 112. Then, by substituting the numerical values of the aforementioned two action features into the retrieved mathematical equation, the learning data generation unit 102 can acquire a degree of similarity. Then, the learning data generation unit 102 puts together the plurality of action features retrieved in S102 and the degree of similarity acquired in the processing in S103 into one set and stores the set into the learning DB 113 as learning data (S104).

The learning data generation unit 102 checks whether a sufficient number of sets of action features and a degree of similarity (learning data) are stored in the learning DB (S105). For example, the learning data generation unit 102 determines whether a predetermined number of pieces or a prespecified number of pieces of learning data are stored in the learning DB 113. When a sufficient number of pieces of learning data are not stored in the learning DB 113 (NO in S105), the learning data generation unit 102 repeats the processing in S102 to S104. On the other hand, when a sufficient number of pieces of learning data are stored in the learning DB 113 (YES in S105), the learning data generation unit 102 ends the processing of generating learning data. In this case, the processing advances to Step S106.

The learning unit 103 retrieves a required number of sets of a degree of similarity and action features (learning data) from the learning DB 113 and performs machine learning considering a degree of similarity (S106). For example, when the Siamese network or the triplet network is used, the learning unit 103 advances learning in such a way as to decrease a value of Loss defined by equation (18) or equation (20) including a degree of similarity as a variable.
1.5 Effect of Present Example Embodiment

As described above, the feature learning system 100 according to the present example embodiment enables learning in consideration of a degree of similarity between actions while not changing the method of identification of an action of a person from a conventional method. Thus, an adverse effect caused by performing learning on “actions similar in appearance but different” can be suppressed, and learning can be stably performed. Specifically, construction of a stable feature space not requiring excessive emphasis on the difference between actions or the like can be achieved, and an effect of improving identification performance with the same identification method as a conventional method can be expected. Further, during learning, while there may be a case of requiring preprocessing such as principal component analysis or advance learning and identification when a degree of similarity is defined, once a degree of similarity is defined, the value can be continuously used in subsequent learning, and a method without preprocessing, such as artificial definition of a degree of similarity, may be employed. Therefore, efforts to prepare learning data used for machine learning can be minimized relative to a conventional technology.
2. Second Example Embodiment
2.1 System Configuration

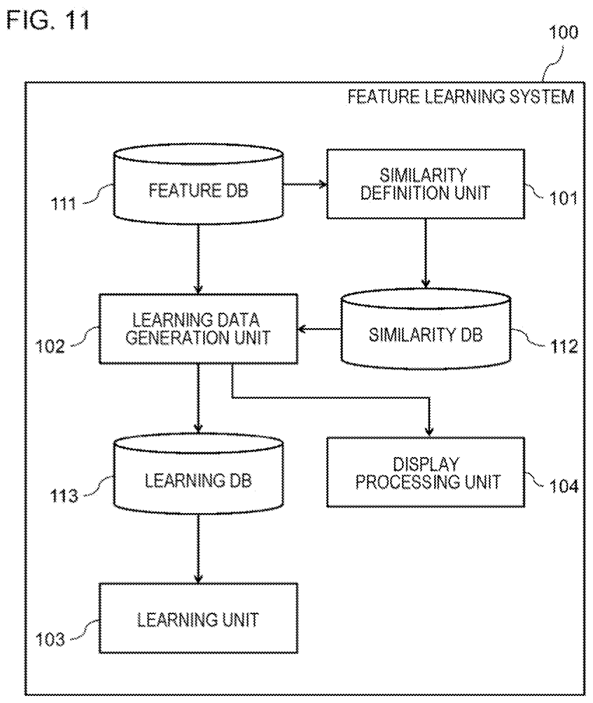

A feature learning system according to the present example embodiment has sustained efficacy similar to that of the first example embodiment except for a point described below. FIG. 11 is a diagram illustrating a configuration of a feature learning system 100 according to the second example embodiment.

As illustrated in FIG. 11, the feature learning system 100 according to the present example embodiment further includes a display processing unit 104. The display processing unit 104 outputs a screen indicating a processing result (such as a determination result of a degree of similarity between action features) by a learning data generation unit 102 on a display (unillustrated) provided for an operator.
2.2 Output Screen Example

A specific example of a screen output by the display processing unit 104 is described below by using diagrams.

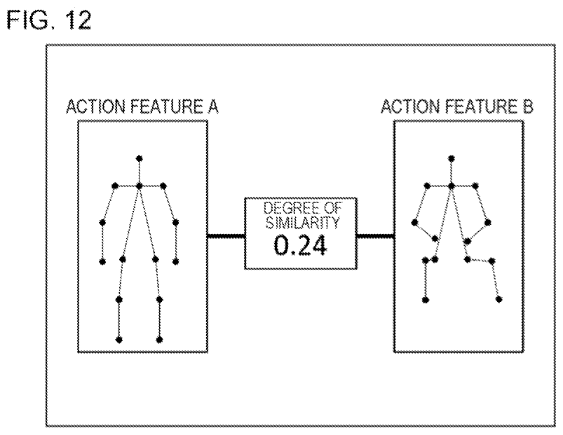

FIG. 12 is a diagram illustrating an example of a screen output by the display processing unit 104. In the example in FIG. 12, the display processing unit 104 displays a screen including information indicating two action features (an action feature A and an action feature B) optionally selected and retrieved from a feature DB 111 and a degree of similarity between the two. A person performing an operation of generating learning data with such a screen can advance the operation while checking a content of the learning data.

Note that a screen output by the display processing unit 104 is not limited to the example in FIG. 12. For example, the display processing unit 104 may generate a screen including two action features in a state of being superposed on each other and output the screen on the display provided for an operator. In this case, for example, the display processing unit 104 may adjust transmissivities of image data of the two action features in such a way as to clarify the difference between the two action features.

Further, the display processing unit 104 may be configured to vary a display mode of each keypoint, based on similarity between keypoints related to two action features. For example, by varying the shape or the color of keypoints with a low (or high) level of similarity, the display processing unit 104 may display the keypoints with greater emphasis placed thereon than other keypoints.

Further, the display processing unit 104 may be configured to output a screen further including a display element allowing an operator to select whether to store learning data generated by the learning data generation unit 102 into a learning DB 113.

Further, the display processing unit 104 may be configured to output a screen further including information indicating a distribution of learning data already stored in the learning DB 113 (such as a distribution based on a degree of similarity included in learning data).

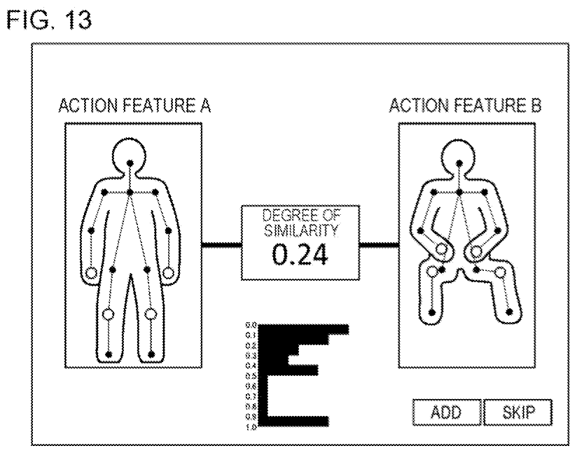

Another example of a screen output by the display processing unit 104 is illustrated in FIG. 13. FIG. 13 is a diagram illustrating another example of a screen output by the display processing unit 104. With the screen illustrated in FIG. 13, an operator can readily recognize parts of two action features that are similar (or not similar), based on a display mode of a keypoint. Further, the operator may check information on the screen, such as contents of learning data and a distribution of learning data in the learning DB 113, select required learning data, and store the learning data into the learning DB 113.
3. Supplementary Information

Note that the configurations according to the aforementioned example embodiments may be combined or may be partially substituted. Further, the configurations of the present invention are not limited to the aforementioned example embodiments, and various changes and modifications may be made without departing from the spirit and scope of the present invention.

Further, while identification of a human action is described herein, the present invention is also applicable to identification of any feature expressible by a vector.

The whole or part of the example embodiments described above may be described as, but not limited to, the following supplementary notes.
1. A feature learning system including:

a similarity definition unit that defines a degree of similarity between two classes related to two feature vectors, respectively;

a learning data generation unit that acquires the degree of similarity, based on a combination of classes to which a plurality of feature vectors acquired as processing targets belong, respectively, and generates learning data including the plurality of feature vectors and the degree of similarity; and

a learning unit that performs machine learning using the learning data.
2. The feature learning system according to 1., in which

the similarity definition unit defines a mathematical equation for determining a degree of similarity between the two classes, based on the two feature vectors, and

the learning data generation unit acquires the mathematical equation for determining a degree of similarity related to a combination of classes to which the plurality of feature vectors acquired as the processing targets belong, respectively, and computes a degree of similarity by substituting the plurality of feature vectors into the mathematical equation.
3. The feature learning system according to 2., in which

the degree of similarity is computed based on a norm of a difference between the feature vectors or between vectors acquired by performing dimensionality reduction on the feature vectors, or an angle formed by the vectors.
4. The feature learning system according to any one of 1. to 3., in which

the learning unit uses metric learning.
5. The feature learning system according to any one of 1. to 4., in which

the degree of similarity is computed based on an angle formed by eigenvectors related to first principal components each acquired for each class to which the feature vector belongs by performing principal component analysis for the each class.
6. The feature learning system according to any one of 1. to 4., in which

the degree of similarity is computed based on a false recognition rate at a time when identification of a class is performed by using the feature vector.
7. The feature learning system according to any one of 1. to 6., in which

the feature vector is a feature of a human action, and

a class to which the feature vector belongs is a type of action to which the feature of the human action belongs.
8. The feature learning system according to 7., in which

the feature of the human action includes sensor information of one or more of a visible light camera, an infrared camera, and a depth sensor.
9. The feature learning system according to 7., in which

the feature of the human action includes human skeletal information, and

the human skeletal information at least includes positional information of one or more of a head, a neck, a left elbow, a right elbow, a left hand, a right hand, a hip, a left knee, a right knee, a left foot, and a right foot.
10. The feature learning system according to 9., in which

the degree of similarity is computed based on a distance between related parts in the human skeletal information or an angle formed by segments connecting parts in the human skeletal information.
11. A feature learning method including, by a computer:

defining a degree of similarity between two classes related to two feature vectors, respectively;

acquiring the degree of similarity, based on a combination of classes to which a plurality of feature vectors acquired as processing targets belong, respectively;

generating learning data including the plurality of feature vectors and the degree of similarity; and

performing machine learning using the learning data.
12. The feature learning method according to 11., further including, by the computer:

defining a mathematical equation for determining a degree of similarity between the two classes, based on the two feature vectors, and

acquiring the mathematical equation for determining a degree of similarity related to a combination of classes to which the plurality of feature vectors acquired as the processing targets belong, respectively, and computing a degree of similarity by substituting the plurality of feature vectors into the mathematical equation.
13. The feature learning method according to 12., in which

the degree of similarity is computed based on a norm of a difference between the feature vectors or between vectors acquired by performing dimensionality reduction on the feature vectors, or an angle formed by the vectors.
14. The feature learning method according to any one of 11. to 13., further including, by the computer,

using metric learning as the machine learning.
15. The feature learning method according to any one of 11. to 14., in which

the degree of similarity is computed based on an angle formed by eigenvectors related to first principal components each acquired for each class to which the feature vector belongs by performing principal component analysis for the each class.
16. The feature learning method according to any one of 11. to 14., in which
   the degree of similarity is computed based on a false recognition rate at a time when identification of a class is performed by using the feature vector.
17. The feature learning method according to any one of 11. to 16., in which

the feature vector is a feature of a human action, and

a class to which the feature vector belongs is a type of action to which the feature of the human action belongs.
18. The feature learning method according to 17., in which

the feature of the human action includes sensor information of one or more of a visible light camera, an infrared camera, and a depth sensor.
19. The feature learning method according to 17., in which

the feature of the human action includes human skeletal information, and

the human skeletal information at least includes positional information of one or more of a head, a neck, a left elbow, a right elbow, a left hand, a right hand, a hip, a left knee, a right knee, a left foot, and a right foot.
20. The feature learning method according to 19., in which

the degree of similarity is computed based on a distance between related parts in the human skeletal information or an angle formed by segments connecting parts in the human skeletal information.
21. A program causing a computer to execute the feature learning method according to any one of 11. to 20.

What is claimed is:

1. A feature learning system comprising:
at least one memory storing instructions; and
at least one processor configured to execute the instructions to perform operations comprising:
defining a degree of similarity between two classes related to two feature vectors, respectively;
acquiring the degree of similarity, based on a combination of classes to which a plurality of feature vectors acquired as processing targets belong, respectively;
generating learning data including the plurality of feature vectors and the degree of similarity; and
performing machine learning using the learning data.

2. The feature learning system according to claim 1, wherein the operations comprise:
defining a mathematical equation for determining a degree of similarity between the two classes, based on the two feature vectors;
acquiring the mathematical equation for determining a degree of similarity related to a combination of classes to which the plurality of feature vectors acquired as the processing targets belong, respectively; and
computing a degree of similarity by substituting the plurality of feature vectors into the mathematical equation.

3. The feature learning system according to claim 2, wherein
the degree of similarity is computed based on a norm of a difference between the feature vectors or between vectors acquired by performing dimensionality reduction on the feature vectors, or an angle formed by the vectors.

4. The feature learning system according to claim 1, wherein
the operation comprise using metric learning.

5. The feature learning system according to claim 1, wherein
the degree of similarity is computed based on an angle formed by eigenvectors related to first principal components each acquired for each class to which the feature vector belongs by performing principal component analysis for the each class.

6. The feature learning system according to claim 1, wherein
the degree of similarity is computed based on a false recognition rate at a time when identification of a class is performed by using the feature vector.

7. The feature learning system according to claim 1, wherein
the feature vector is a feature of a human action, and
a class to which the feature vector belongs is a type of action to which the feature of the human action belongs.

8. The feature learning system according to claim 7, wherein
the feature of the human action includes sensor information of one or more of a visible light camera, an infrared camera, and a depth sensor.

9. The feature learning system according to claim 7, wherein
the feature of the human action includes human skeletal information, and
the human skeletal information at least includes positional information of one or more of a head, a neck, a left elbow, a right elbow, a left hand, a right hand, a hip, a left knee, a right knee, a left foot, and a right foot.

10. The feature learning system according to claim 9, wherein
the degree of similarity is computed based on a distance between related parts in the human skeletal information or an angle formed by segments connecting parts in the human skeletal information.

11. A feature learning method comprising, by a computer:
defining a degree of similarity between two classes related to two feature vectors, respectively;
acquiring the degree of similarity, based on a combination of classes to which a plurality of feature vectors acquired as processing targets belong, respectively;
generating learning data including the plurality of feature vectors and the degree of similarity; and
performing machine learning using the learning data.

12. A non-transitory computer readable medium storing a program causing a computer to execute a feature learning method, the method comprising:
defining a degree of similarity between two classes related to two feature vectors, respectively;
acquiring the degree of similarity, based on a combination of classes to which a plurality of feature vectors acquired as processing targets belong, respectively;
generating learning data including the plurality of feature vectors and the degree of similarity; and
performing machine learning using the learning data.
